(19) United States
(12) Patent Application Publication
(10) Pub. No.: US 2021/0339113 A1
(43) Pub. Date: Nov. 4, 2021

(54) MULTICORE SNOWBOARD CONSTRUCTION AND PRODUCTION METHOD

(71) Applicant: C & D Enterprises Ltd, Denver, CO (US)

(72) Inventor: Daniel Erik Ekker, Denver, CO (US)

(21) Appl. No.: 17/283,416

(22) PCT Filed: Oct. 3, 2019
(86) PCT No.: PCT/US2019/054437

§ 371 Date: Apr. 7, 2021

Related U.S. Application Data
(60) Provisional application No. 62/743,123, filed on Oct. 9, 2018.

(51) Int. Cl. A63C 5/12; A63C 5/03; B32B 21/10; B32B 5/02; B32B 21/08; B32B 7/12

(52) U.S. Cl. CPC A63C 5/126; A63C 5/03; B32B 21/10; B32B 5/024; B32B 2250/05; B32B 7/12; B32B 2307/732; B32B 2262/106; B32B 2262/0253; B32B 21/08

(57) ABSTRACT

A snowboard having a multicore construction comprising a plurality of layers, including at least two wood cores separated by an inner composite layer, and outer composite layers arranged between a wood core and the base or top sheet of the snowboard, respectively. Also, a production method for a multicore snowboard design.

### BACKGROUND

Modern snowboards generally comprise several layers of high-density plastics and composite material arranged on either side of a single wood core, which together form the structure of the snowboard. For example, in a typical multilayer construction: the base forms the bottom layer, a first fiberglass composite layer is arranged above the base, the core is arranged above the first fiberglass layer, a second fiberglass composite layer is arranged above the core, and the top sheet forms the top layer. In this way, the center core is enclosed by a so-called fiberglass sandwich.

The core provides the central structure upon which the other layers are attached and determines much of the snowboard's principal properties and characteristics, including longitudinal and torsional stiffness/flexibility and strength for example. Cores are generally made from vertically laminated strips of hardwoods. Other materials have sometimes been used to replace wood as the primary core material. Nonetheless, wood cores have generally remained the standard in the snowboard industry due to the combination of overall performance and relative cost compared to other materials. With foam cores, for example, the foam cells are susceptible to breaking down at a relatively fast rate, meaning characteristics such as board camber and stiffness/flexibility may diminish quicker compared to wood cores; although soft foam cores can be desirable in beginner boards for learning to turn.

The fiberglass composite layers encompassing the center core generally act to reinforce the core, augmenting strength and preventing deformation, as well as increase the stiffness of the board. Because wood cores are relatively thin (typically between 5-7 mm thick) and subject to considerable forces when riding, the fiberglass composite reinforcement helps prevent the wood core from snapping. The fiberglass composite layers are generally provided as a single sheet of either biaxial or triaxial fabric. Other composites have been added to fiberglass constructions to enhance board characteristics. For example, carbon fiber composites-in both whole sheet and specific cut patterns-have been provided on either side of the core to increase strength and rigidity. Aramid fibers like polyparaphenylene terephthalamide have also been used.

One significant consideration in snowboard design is weight. All else equal, lighter constructions are generally more desirable than heavier constructions, since lighter boards are typically livelier and more responsive to rider input. However, a substantial barrier to weight reduction has been the high-density fiberglass layers that reinforce the wood core. While carbon fiber is considerably lighter than fiberglass, it is also considerably less flexible, meaning that replacing the fiberglass sandwich with a pure carbon fiber sandwich would make the snowboard too stiff for many riders. Many lightweight materials lack the necessary balance between strength and rigidity for adequate structural reinforcement of the wood core at reasonable cost.

The foregoing examples of the related art and limitations therewith are intended to be illustrative and not exclusive. Other limitations of the related art will become apparent to those of skill in the art upon a reading of the specification and a study of the drawings.

### SUMMARY

The present disclosure relates to a snowboard design having a multicore construction and a production method therefor. One aspect is to split the singular wood core of conventional snowboard designs into two or more cores. Another aspect is to move the primary reinforcement layer between the two or more cores. Another aspect is to eliminate the need for fiberglass reinforcement exterior to the core. Another aspect is to provide a lightweight construction. Another aspect is to provide a high strength construction. Another aspect is to provide a snowboard that is relatively more flexible at lower speeds, and yet stiffer at higher speeds. Another aspect is to increase the expected lifetime use of the snowboard. Another aspect is to provide a method for producing a snowboard according to the present disclosure.

A multicore snowboard according to the present disclosure comprises a plurality of layers, including a base layer, a first outer composite layer, a second outer composite layer, at least one inner composite layer, at least two wood cores, and a top sheet layer. The base layer forms the bottom gliding surface of the snowboard. The base layer is arranged adjacent to the first outer composite layer. The first outer composite layer is arranged between the base layer and one of the at least two wood cores. The at least one inner composite layer is arranged between two of the at least two wood cores. The second outer composite layer is arranged between the top sheet layer and one of the at least two wood cores. The top sheet layer is arranged adjacent to the second outer composite layer. The top sheet layer forms the top surface of the snowboard that the rider stands on.

In some embodiments, the snowboard may have exactly two wood cores. For example, the wood cores may together form a total thickness of approximately 5-7 mm. Each of the wood cores may have a thickness of approximately 2.5-3.5 mm. For example, the total thickness of the wood cores may be approximately 6 mm. Likewise, both wood cores may be approximately 3 mm thick. In other embodiments, the snowboard may have at least two inner composite layers and at least three wood cores, wherein each inner composite layer is arranged between two wood cores, and at least one wood core is arranged between two inner composite layers.

In some embodiments, the inner composite layer may comprise at least one sheet of carbon fiber composite. The carbon fiber composite may be biaxial or triaxial. Each of the outer composite layers may comprise at least one sheet of composite material. For example, the outer composite layer may comprise a sheet or sheets of high modulus polypropylene composite. The high modulus polypropylene composite may be biaxial or triaxial. Additional materials and layers may be also added to the inner and outer composite layers.

A production method for a multicore snowboard according to the present disclosure comprises a component assembly process wherein the base with steel edges is arranged in a mold, the first outer composite layer is arranged on the base in the mold, the first wood core is arranged on the first outer composite layer in the mold, the inner composite layer is arranged on the first wood core in the mold, the second wood core is arranged on the inner composite layer in the mold, the second outer composite layer is arranged on the second wood core in the mold, and the top sheet is arranged on the second outer composite layer in the mold. The steel edges may be affixed to the base prior to arranging the base in the mold. Additional wood cores and inner composite layers may be added for multicore constructions having more than two wood cores. The mold may be a cassette mold for example.

Further assembly steps may include applying a bonding agent to the base prior to arranging the first outer composite layer on the base in the mold, applying a bonding agent to the first outer composite layer prior to arranging the first wood core on the first outer composite layer, applying a bonding agent to the first wood core prior to arranging the inner composite layer on the first wood core, applying a bonding agent to the inner composite layer prior to arranging the second wood core on the inner composite layer, applying a bonding agent to the second wood core prior to arranging the second outer composite layer on the second wood core, and applying a bonding agent to the second outer composite layer prior to arranging the top sheet on the second composite layer. Epoxy may be used for the bonding agent for example.

In embodiments with rubber dampeners, the rubber dampeners may be affixed to the steel edges arranged on the base in the mold, but before arranging the first outer composite layer on the base. In embodiments with sidewalls, the sidewall may be arranged around sides of the first wood core, the inner composite layer, and the second wood core, prior to arranging the second outer composite layer on the second wood core in the mold. Further, a bonding agent may be applied to the sides of the first wood core, the inner composite layer, and the second wood core, prior to arranging the sidewall around these components.

In a press forming process after assembly, the mold and the components of the snowboard arranged therein are placed in a press under pressure and temperature for a period of time to shape and join components of the snowboard. Once the components of the assembly are effectively joined together and set in the desired side profile shape, the press-formed snowboard is taken out of the press and removed from the mold. At this point, any excess material may be cut and/or polished from the assembled snowboard during a finishing process.

If the components are not prefabricated for assembly, the production method may include a preliminary preparation process before the assembly process. Initial steps may include cutting two wood billets into a specified shape to form the first wood core and the second wood core, planning each of the first and second wood cores to a specified thickness to accommodate the inner composite layer, and cutting the inner composite layer to size for insertion between the first and second wood cores. In some embodiments, the wood billets may be formed by vertically laminating pieces of wood together. In embodiments with a sidewall, the sidewall may be added prior to planning the first and second wood cores to the specified thickness to ensure the correct amount of sidewall material is provided for later assembly. Additional wood cores and inner composite layers may be prepared in this way for multicore constructions having more than two wood cores. The other components of the assembly may also be shaped and otherwise prepared for assembly during this preliminary step. It should be appreciated that the component preparation steps and any assembled snowboard finishing steps need not necessarily be performed at the same time or location, or even by the same party, as the mold assembly and press forming steps.

The multicore snowboard construction and production method according to the present disclosure is compatible with various side edge structural designs including, for example, sidewall, cap and half-cap configurations. Likewise, the multicore construction and production method may be used for various board shapes and profile types.

The following embodiments and aspects thereof are described and depicted in conjunction with systems, tool and methods which are meant to be illustrative, not limiting in scope. In various embodiments, one or more of the above described problems have been reduced or eliminated, while other embodiments are directed to other improvements.

### BRIEF DESCRIPTION OF THE DRAWINGS

The present disclosure is described hereinafter based on illustrative embodiments with reference to the following figures:

FIG. 1 shows a top plan view of a snowboard;

FIG. 2 shows a partial sectional view of a multicore snowboard construction according to the present disclosure, taken along line A-A of FIG. 1;

FIG. 3 shows a partial sectional view of another multicore snowboard construction according to the present disclosure, taken along line A-A of FIG. 1;

FIG. 4 shows a partial sectional view of a possible side edge configuration for a multicore snowboard, taken along line A-A of FIG. 1;

FIG. 5 shows a partial sectional view of another possible side edge configuration for a multicore snowboard, taken along line A-A of FIG. 1;

FIG. 6 shows a partial sectional view of another possible side edge configuration for a multicore snowboard, taken along line A-A of FIG. 1; and

FIG. 7 shows a schematic block diagram of the steps in a production method for a multicore snowboard according to the present disclosure.

Before further explaining the depicted embodiments, it is to be understood that the invention is not limited in its application to the details of the particular arrangements shown, since the invention is capable of other embodiments. It is intended that the embodiments and figures disclosed herein are to be considered illustrative rather than limiting. Also, the terminology used herein is for the purposes of description and not limitation.

### DETAILED DESCRIPTION

Certain terminology is used in the following description for the purposes of clear and concise explanation, and should not be considered or construed as limiting. For example, terms such as “connected” or “attached” include both directly and indirectly connected or attached, respectively. This convention applies not only to these specific terms, but also to similar, related, and derivative terms and phrases as well.

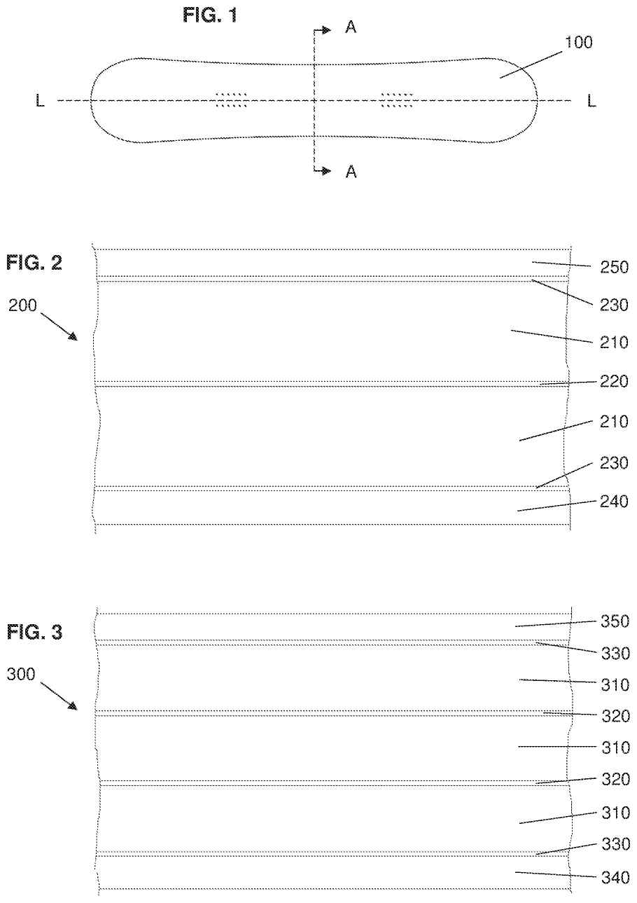

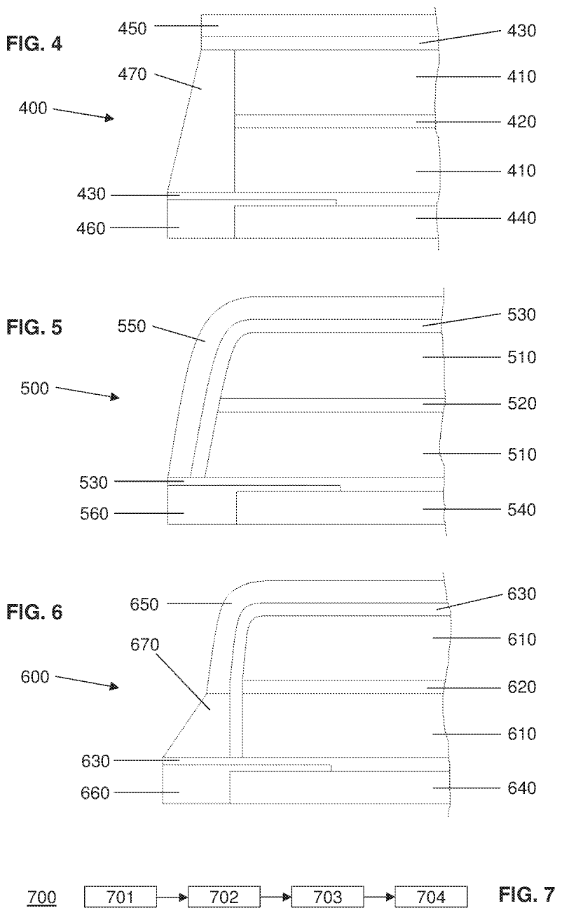

FIG. 1 depicts a top plan view of a snowboard 100 and indicates context for sectional views used in this description. A longitudinal axis L extends through the center length of the snowboard 100. Binding holes are visible along the surface of the snowboard's top sheet. The binding holes may have threaded inserts therein for securely mounting boot bindings to the snowboard 100. Although binding holes are illustrated, it should be appreciated that any other suitable mounting configuration for bindings (e.g., a channel mounting system) may be used with a multicore snowboard construction according to the present disclosure and production method therefor. FIGS. 2 through 6 show sectional views of snowboard constructions taken along line A-A of FIG. 1. The cross sections of FIGS. 2 and 3 depict the middle portion of the snowboard 100 (which generally corresponds to the location of the longitudinal axis L in FIG. 1) and omit the edge portions of the snowboard 100 (which correspond to the lateral sides of the snowboard along line A-A furthest from the longitudinal axis L in FIG. 1). The cross sections of FIGS. 4 through 6 depict one of the edge portions of the snowboard 100 and omit the middle portion of the snowboard 100, as well as the opposite edge portion.

FIG. 2 shows an embodiment of a multicore snowboard construction 200 according to the present disclosure. The layered construction of the snowboard 200 comprises two wood cores 210 arranged on either side of an inner composite layer 220. On the other side of each wood core 210 from the inner composite layer 220, an outer composite layer 230 is provided adjacent to each of the wood cores 210. One composite layer 230 is arranged between the respective wood core 210 and the base layer 240. The other outer composite layer 230 is arranged between the respective wood core 210 and the top sheet layer 250.

The wood cores 210 determine much of the principal properties or characteristics of the snowboard, including longitudinal and torsional stiffness/flexibility and strength for example. Each wood core 210 may be made from a plurality of laminated wood strips joined by an adhesive. In some embodiments, the wood strips may be vertically laminated together to form the wood core 210. In others, the wood strips could be thin sheets horizontally laminated together. Still further, the wood core 210 could also be formed from a single piece of wood. Example woods include aspen, bamboo, beech, birch, poplar and other hardwoods, or mixtures thereof.

The inner composite layer 220 provides the primary reinforcement to adjacent wood cores 210, augmenting the strength and preventing deformation of the wood, while also increasing the rigidity of the snowboard. In this way, the inner composite layer 220 helps retain the shape of the wood cores 210 and reduce the risk that the wood cores 210 will break under structural stress. In some embodiments, the inner composite layer 220 comprises a carbon fiber composite. The carbon fiber composite may be provided as a single sheet of material overlaying the entirety of the wood cores 210. In other embodiments, more than one sheet or specific cutout patterns of carbon fiber composite may be provided between adjacent cores. The carbon fiber composite layer may be woven into a biaxial or triaxial fabric configuration. Regarding performance, carbon fiber has relatively high strength, fatigue, and rigidity properties, and relatively low weight and thermal expansion properties. Thus, carbon fiber composite performs well in the role of the inner composite layer 220. However, other materials could also be used instead of, or in combination with, carbon fiber for the inner composite layer 200 in the multicore snowboard construction 200. For example, fiberglass composites, aramid fiber composites like polyparaphenylene terephthalamide, or high modulus polypropylene (HMPP) composites could also be used, provided that the wood cores 210 remain sufficiently reinforced by the particular composition of the inner composite layer 220 being used. Indeed, the inner composite layer materials can be selected to achieve different board characteristics by design, such as degree of rigidity, weight, strength, resistance to thermal expansion, etc.

An outer composite layer 230 is arranged adjacent each wood core 210 opposite the inner composite layer 220, between the wood core 210 and either the base 240 or top sheet 250. By providing a strong reinforcing layer (inner composite layer 220) in between the separate wood cores 210, the multicore snowboard construction 200 eliminates the need to have strong reinforcing sandwich layers surrounding the exterior of the wood cores 210. Therefore, the outer composite layers 230 need not necessarily be designed to handle the force loads experienced by a snowboard while riding, since the inner composite layer 220 may be primarily responsible for reinforcing the wood cores 210. In this way, other materials can instead be used to encompass the wood cores 210 and enhance certain characteristics of the snowboard. Each of the outer composite layers 230 may comprise at least one sheet of composite material. In some embodiments, one or both outer composite layers 230 comprise a high modulus polypropylene (HMPP) composite. For example, the HMPP composite may be provided as a single sheet of material overlaying the entirety of the wood cores 210 in each outer composite layer 230. In other embodiments, more than one sheet or specific cutout patterns of HMPP composite may be provided. The HMPP composite sheet or sheets may be woven in a biaxial or triaxial fabric configuration. In one embodiment, each of the outer composite layers 230 may comprise a sheet of triaxial HMPP composite arranged adjacent to the respective wood core 210, and a sheet of biaxial HMPP composite arranged adjacent to this sheet of triaxial HMPP composite. Further, a layer of HMPP/carbon composite could be provided for structural support of the other HMPP sheets. For example, parallel carbon fibers along the longitudinal axis may be joined together via perpendicular HMPP fibers in a biaxial weave or net. These strands of fiber may be relatively widely spaced apart from each other, as in an open or loose woven fabric, to preserve board flexibility. This HMPP/carbon composite net may be provided between the other HMPP sheets in one of the outer composite layers 230, such as the topmost outer composite layer 230 adjacent the top sheet 250, or in both outer composite layers 230. Regarding performance, HMPP fibers have a lower weight density than glass and many other fibers. The relative decrease in material weight results in a livelier snowboard that is more responsive to rider input. Furthermore, HMPP composites are relatively flexible with good impact resistance and energy absorbance properties, which allows the outer composite layers 230 to be more flexible under low stress and more rigid under higher stress. In this way, the snowboard may be more forgiving at lower speeds yet stiffer at higher speeds (where softer boards are generally undesirable, since the board's high responsiveness can cause control issues due to the increased frequency and magnitude of forces transmitted through the board to the rider when traversing uneven terrain at such velocities).

It should be appreciated that other materials (e.g., basalt fiber), either alone or in combination, may also be used in the outer composite layer 230. Moreover, the outer composite layer 230 need not contain HMPP composite at all. The materials can be selected to achieve different board characteristics by design, such as degree of rigidity, weight, strength, resistance to thermal expansion, etc. For example, the outer composite layers 230 could also still comprise fiberglass composite, either in whole or in part. Although the use of fiberglass will generally result in a heavier snowboard, at least compared to lighter composites available for the outer composite layers 230 in a multicore construction according to present disclosure, the provision of a primary core reinforcement layer (inner composite layer 220) between separate wood cores 210 itself significantly improves the overall strength of the snowboard. Therefore, a multicore construction with fiberglass outer composite layers may be provided for reasons solely related to strength, particularly if weight is not an important consideration or a heavier weight is in fact desired for the contemplated snowboard design. Other possible considerations might include the cost and/or availability of fiberglass compared to other composites. The scope and spirit of the present disclosure is not necessarily limited to the exclusion of fiberglass in the outer composite layers.

The base layer 240 and the top sheet layer 250 form the exterior bottom and top surfaces of the snowboard construction 200, respectively. In this way, the base 240 provides the primary gliding surface of the snowboard in traversing terrain. The base 240 may be shaped to accommodate edges, typically made of steel, which form the peripheral corners of the snowboard's bottom gliding surface and provide a hard structure for digging into the terrain during turns (see FIGS. 4 through 6). In some embodiments, the base 240 may be made of extruded or sintered polyethylene plastic. Additives, such as graphite and certain metals for example, may be added to the base to augment physical, thermal, and electrical properties. The edges may be affixed to the base 240 with adhesive, for example, a metal-to-plastic glue where the base is polyethylene. The top sheet 250 may be made of plastic, wood and/or carbon. The base 240 and top sheet 250 also provide weatherproofing to prevent degradation of internal materials. Decorative graphics may be printed on nonstructural material layers underlying the base and/or top sheet (not shown), or directly formed into the base and/or top sheet (e.g., sublimation printed). Of course, other materials could also be used for the base and top sheet layers within the scope and spirit of the present disclosure.

FIG. 3 shows another embodiment of a multicore snowboard construction 300 according to the present disclosure. Here, the layered construction of the snowboard 300 comprises three wood cores 310 and two inner composite layers 320. The inner composite layers 320 are each arranged between two of the three wood cores 310. An outer composite layer 330 is provided next to each of the two outermost wood cores 310, with a base layer 340 and a top layer 350 each being arranged exterior to one of the outer composite layers 330. The snowboard design 300 may otherwise be the same as the snowboard design 200 of FIG. 2 in other aspects as described above. It should be appreciated that other multicore constructions are possible within the scope and spirit of the present disclosure, including constructions having more than three wood cores for example (not shown).

In FIGS. 2 and 3, each of the wood cores 210, 310 are shown as being equal or substantially equal in thickness. For example, each wood core 210 of the dual-core design 200 may be approximately 2.5 to 3.5 mm thick, for a total wood material thickness of approximately 5 to 7 mm. In one embodiment, each wood core 210 is approximately 3 mm thick, for a total wood material thickness of approximately 6 mm. A prototype of this embodiment with a 159 cm board length was less than 5 pounds (2.27 kg). Similarly, each wood core 310 of the tri-core design 300 may be approximately 1.6 to 2.4 mm thick, for a total wood material thickness of approximately 5 to 7 mm. In one embodiment, each wood core 310 is approximately 2 mm thick, for a total wood material thickness of approximately 6 mm. Of course, the total wood material thickness of these specified board constructions 200, 300 may be less than or greater than 6 mm-even less than 5 mm or greater than 7 mm-depending on the specific snowboard model being produced, which may vary with the intended riding style (e.g., freestyle, freeride, all-mountain, etc.) and rider demographic. Furthermore, the wood cores 210, 310 need not have the same thickness. In some embodiments, rather, the total wood material thickness may be apportioned differently across the wood cores 210, 310 to achieve desired attributes. For example, in the dual-core design 200, the bottom core could be thicker than the top core to increase strength, since terrain forces are generally transmitted through the bottom core first. Likewise, in the tri-core design 300, the middle core could be thinner than the top and bottom cores, since the middle core abuts the inner composite layers 320 on both sides and is therefore more structurally reinforced in comparison to the top and bottom cores. Of course, other configurations are also possible within the scope and spirit of the present disclosure.

Regarding other layers, the base 240, 340 may be approximately 1.5 to 2 mm thick in some embodiments. The top sheet 250, 350 may be approximately 1 to 1.5 mm thick in some embodiments. The thickness of the composite layers 220, 230 will typically vary depending on material. For example, a sheet of carbon fiber composite is thinner than a sheet of fiberglass or HMPP composite. Further, thickness may vary with weight, weave pattern, number of sheets, etc. that are used in the specific construction, and could be 0.1 mm or thinner in some cases. Therefore, it should be appreciated that the sectional views of the figures are not necessarily to scale, and that the thickness of the composite layers-although variable depending on the specific construction of the composite layer in a given embodiment-will generally represent a small proportion of the overall thickness of the snowboard.

FIGS. 4 through 6 illustrate one of the edge portions of the snowboard with possible side edge configurations 400, 500, 600. Although a dual-core snowboard construction like in FIG. 2 is shown, the side edge configurations 400, 500, 600 could be used in multicore snowboard constructions having more than two wood cores as well. Furthermore, it should be appreciated that other possible side edge configurations may also be used in a multicore snowboard construction within the scope and spirit of the present disclosure. The snowboard comprises steel edges 460, 560, 660 arranged laterally adjacent to the base 440, 540, 640 to form the peripheral corners of the snowboard's bottom gliding surface, which provide hard structures for digging into terrain when turning. In the depicted embodiments, the steel edges 460, 560, 660 at least partially overlay the base 440, 540, 640 in extending inward between the bottom outer composite layer 430, 530, 630 and the top surface of the base 440, 540, 640 to anchor the edges 460, 560, 660 within the layered construction. In other embodiments (not shown), the lateral portions of the top surface of the base 440, 540, 640 may be recessed to receive the inward extensions of the steel edges 460, 560, 660, such that the top surface of the edges 460, 560, 660 is level or substantially level to the non-recessed portions of the top surface of the base 440, 540, 640. The steel edges 460, 560, 660 may be affixed to the base 440, 540, 640 with adhesive (e.g., a metal-to-plastic glue where the base is polyethylene).

Vibration dampeners (not shown), typically rubber, may be provided between the steel edges 460, 560, 660 and the bottom outer composite layer 430, 530, 630. For example, the rubber dampeners may include one or more thin strips of material (e.g., about 0.25 in) which cover the top surface of the steel edges 460, 560, 660. The rubber dampeners can help reduce the transmission of vibrations from the steel edges 460, 560, 660 to rest of the snowboard. The rubber dampeners also provide an intermediary material between the steel edges and other components for bonding.

Above the steel edges and/or rubber dampeners, the edge portions of the snowboard construction may have a sidewall configuration 400, cap configuration 500, or half-cap configuration 600, or any other suitable configuration since the present disclosure is not so limited. In the sidewall design 400 of FIG. 4, a sidewall structure 470 for shock absorption is sandwiched between the outer composite layers 430 around the lateral sides of the wood cores 410. In the cap design 500 of FIG. 5, the top sheet 550 and the outer composite layer 530 adjacent to the top sheet 550 extend over the lateral sides of the wood cores 510 to encapsulate and protect the wood cores 510. In the half-cap design 600 of FIG. 6, the outer composite layer 630 adjacent to the top sheet 650 extends over the lateral sides of the wood cores 610 to encapsulate and protect the wood cores 610, with a sidewall structure 670 being arranged laterally adjacent thereto underneath the top sheet 650 for shock absorption. The sidewalls 470, 670 may be made of acrylonitrile butadiene styrene (ABS), for example. Urethane could also be used for the sidewalls 470, 670 to decrease weight. The snowboard could also have a hybrid design with different configurations in the nose, tail, and/or lateral sides.

Turning now to the manufacture of a multicore snowboard, FIG. 7 shows a schematic block diagram comprising steps of a production method 700 according to the present disclosure. The above-described snowboard constructions and aspects thereof may be produced according to the production method 700.

In a preliminary step 701, the wood cores may be prepared for assembly. For example, multiple pieces of wood could be laminated together to form one or more wood billets. The pieces of wood may be vertically or horizontally laminated. In an embodiment of the production method for a dual-core construction, two wood billets are stacked together and cut into the correct size and shape for the snowboard model being produced, which can vary depending on the intended riding style (e.g., freestyle, freeride, all-mountain, etc.) and the intended directionality (e.g., symmetrical twin-tip boards for alternating downhill orientation, asymmetrical swallowtail boards for a single downhill orientation, etc.). CNC machine milling may be used to cut the billets to the specified dimensions. If the snowboard design comprises a sidewall, the sidewall may be added to the stacked wood cores at this point to ensure the thickness of the sidewall material is proper for a snowboard that would only have a single wood core. The wood cores may then be planed to accommodate the insertion of the inner composite layer between them. The inner composite layer may then be cut to size to ensure a proper fit between the wood cores. This process for preparing the wood cores may be readily adapted for a snowboard having more than two cores (e.g., tri-core constructions, etc.). Of course, the other components of the snowboard construction may also be prepared for assembly during the preliminary step 701. Likewise, components may be processed for binding holes/inserts or other binding mounting configurations (e.g., channel mounting systems) prior to assembly according to production methods known in the industry.

In an assembly step 702, the various components that together will form an integral snowboard are positioned inside a mold. The mold may be an aluminum cassette mold for example, though any other suitable type of mold could also be used. First, the base layer is arranged in the mold. The base layer may then be wet out with epoxy. The steel edges may be affixed to the base prior to placing the base in the mold, for example during the preliminary step 701, to ensure the steel edges are properly mounted and aligned before beginning the overall assembly step 702. Alternatively, the steel edges may be affixed to the base during the assembly step 702. In embodiments with rubber dampeners, the steel edges may be wet out and the rubber dampeners placed over the steel edges, before an outer composite layer is arranged on the base in the mold, in which case the top of the rubber dampeners may also be wet out before the outer composite layer is applied. Next, a first outer composite layer is arranged on the base in the mold. The first outer composite layer may then be wet out with epoxy. Next, a first wood core is arranged on the first outer composite layer in the mold. The first wood core may then be wet out with epoxy. Next, an inner composite layer is arranged on the first wood core in the mold. The inner composite layer may then be wet out with epoxy. Next, a second wood core is arranged on the inner composite layer in the mold. The second wood core may then be wet out with epoxy. In embodiments with sidewalls, the sides of the first wood core, the inner composite layer, and the second wood core may be wet out and the sidewall placed around the sides of these components, before an outer composite layer is arranged on the second wood core in the mold. Next, a second outer composite layer is arranged on the second wood core in the mold. The second outer composite layer may then be wet out with epoxy. Next, a top sheet is arranged on the second outer composite layer in the mold. While epoxy resin is generally referenced here, other adhesive bonding agents could also be used alternatively or at different points during the assembly process 702, including within the same construction, provided the bonding agent is suitable for the materials being joined (e.g., metal-to-plastic, wood-to-composite, etc.) and that the bond formed is sufficiently able to endure the expected conditions and loads experienced by the snowboard. The scope and spirit of the present disclosure is not limited by any particular bonding agent.

In a forming step 703, the mold is placed in a machine press under pressure and temperature for a period of time. The pressure and temperature generated may vary with the technical specifications of the particular press being used. In general, the pressure, temperature, and duration of the pressing process are selected to ensure activation and/or setting of the bonding agent(s). Therefore, the selected values of these parameters will typically depend on the bonding agent(s) being used for component assembly. In an embodiment using epoxy, for example, the pressure may be about 3 bar (300 kPa) and the temperature may be about 170° F. (76° C.) for a period of about 20 minutes or less. In another embodiment, a relatively higher pressure may be used to press any excess epoxy out of the multicore construction, since the multicore construction has additional layers and therefore additional bonding agent between these layers, as compared to an otherwise identical single-core construction, at a location farther from the tool surfaces of the machine press applying the pressure. For example, the pressure may be increased to approximately bar (500 kPa) in this case. Other values for pressure, temperature, and time could also be used during the forming step 703, with conditions inside the press being adjusted relative to one another to ensure the snowboard components have been fully set before removal (e.g., by leaving the snowboard in the press longer if under a lower pressure). Again, however, the potential range of effective adjustments for a given parameter may be limited by the specific requirements of the particular bonding agent(s) being used (e.g., a minimum temperature requirement for thermosetting). The machine press tool surfaces which act on the mold can be configured to shape the components into the desired side profile for the snowboard model being produced (e.g., flat, camber, reverse camber, etc.). Once the components are fully joined and set in the desired profile shape, the press-formed snowboard may be taken out of the press and removed from the mold. At this point, any excess material may be cut and/or polished from the assembled snowboard during a finishing step 704. It should be appreciated that the component preparation process 701 and snowboard finishing process 704 need not necessarily be performed at the same time or location, or even by the same party, as the mold assembly and press forming steps 702, 703.

While a number of aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations, which are within their true spirit and scope. Each embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. Whenever a range is given in the specification, all intermediate ranges and subranges, as well as all individual values included in the ranges given are intended to be included in the disclosure. When a Markush group or other grouping is used herein, all individual members of the group and all combinations and sub-combinations possible of the group are intended to be individually included in the disclosure.

In general, the terms and phrases used herein have their art-recognized meaning, which can be found by reference to standard texts, journal references and contexts known to those skilled in the art. The above definitions are provided to clarify their specific use in the context of the invention.

A set of apparatus claims in accordance with the present disclosure may possibly include:

1. A snowboard having a multicore construction comprising:
a plurality of layers including a base layer forming a gliding surface of the snowboard, a first outer composite layer, a second outer composite layer, at least one inner composite layer, at least two wood cores, and a top sheet layer;
wherein the base layer is arranged adjacent to the first outer composite layer;
the first outer composite layer is arranged between the base layer and one of the at least two wood cores;
the at least one inner composite layer is arranged between two of the at least two wood cores;
the second outer composite layer is arranged between the top sheet layer and one of the at least two wood cores; and the top sheet layer is arranged adjacent to the second outer composite layer.
   2. The snowboard of claim 1, further comprising at least two inner composite layers and at least three wood cores, wherein each inner composite layer is arranged between two wood cores, and at least one wood core is arranged between two inner composite layers.
   3. The snowboard of claim 1, wherein the snowboard has exactly two wood cores.
   4. The snowboard of claim 3, wherein each of the two wood cores is approximately 2.5-3.5 mm thick.
   5. The snowboard of claim 4, wherein each of the two wood cores is approximately 3 mm thick.
   6. The snowboard of any of the preceding claims, wherein the wood cores together have a total thickness of approximately 5-7 mm.
   7. The snowboard of claim 6, wherein the total thickness of the wood cores is approximately 6 mm.
   8. The snowboard of any of the preceding claims, wherein the at least one inner composite layer comprises a sheet of carbon fiber composite.
   9. The snowboard of claim 8, wherein the sheet of carbon fiber composite is biaxial or triaxial woven.
   10. The snowboard of any of the preceding claims, wherein the first outer composite layer comprises a sheet of high modulus polypropylene composite.
   11. The snowboard of claim 10, wherein the sheet of high modulus polypropylene composite is biaxial or triaxial woven.
   12. The snowboard of any of the preceding claims, wherein the second outer composite layer comprises a sheet of high modulus polypropylene composite.
   13. The snowboard of claim 12, wherein the sheet of high modulus polypropylene composite is biaxial or triaxial woven.
   14. The snowboard of any of claims 1 through 9, wherein the first outer composite layer and the second outer composite layer each comprise a sheet of high modulus polypropylene composite.
   15. The snowboard of claim 14, wherein the sheet of high modulus polypropylene composite is biaxial or triaxial woven.

A set of method claims in accordance with the present disclosure may possibly include:

1. A method for producing a snowboard having a multicore construction, comprising the steps of:
arranging a base with steel edges in a mold;
arranging a first outer composite layer on the base in the mold;
arranging a first wood core on the first outer composite layer in the mold;
arranging an inner composite layer on the first wood core in the mold;
arranging a second wood core on the inner composite layer in the mold;
arranging a second outer composite layer on the second wood core in the mold;
arranging a top sheet on the second outer composite layer in the mold; and placing the mold in a press for a period of time under pressure and temperature to shape and join components of the snowboard.
   2. The method of claim 1, further comprising the step of arranging a sidewall around sides of the first wood core, the inner composite layer, and the second wood core, prior to arranging the second outer composite layer on the second wood core in the mold.
   3. The method of claim 2, further comprising the step of applying a bonding agent to the sides of the first wood core, the inner composite layer, and the second wood core, prior to arranging the sidewall around the side of the first wood core, the inner composite layer, and the second wood core.
   4. The method of any of the preceding claims, further comprising the steps of:
applying a bonding agent to the base prior to arranging the first outer composite layer on the base in the mold;
applying a bonding agent to the first outer composite layer prior to arranging the first wood core on the first outer composite layer in the mold;
applying a bonding agent to the first wood core prior to arranging the inner composite layer on the first wood core in the mold;
applying a bonding agent to the inner composite layer prior to arranging the second wood core on the inner composite layer in the mold;
applying a bonding agent to the second wood core prior to arranging the second outer composite layer on the second wood core in the mold; and
applying a bonding agent to the second outer composite layer prior to arranging the top sheet on the second composite layer in the mold.
   5. The method of claim 3 or 4, wherein epoxy is used for the bonding agent.
   6. The method of any of the preceding claims, further comprising the initial steps of: cutting two wood billets into a specified shape to form the first wood core and the second wood core;
each of the first and second wood cores to a specified thickness to accommodate the inner composite layer; and
cutting the inner composite layer to size for insertion between the first and second wood cores.
   7. The method of claim 6, further comprising the step of vertically laminating pieces of wood together to form each of the two wood billets.
   8. The method of claim 6 or 7, wherein a sidewall is added around the first and second wood cores prior to planning the first and second wood cores in order to correctly size the sidewall for later assembly.
   9. The method of any of the preceding claims, further comprising the step of affixing the steel edges to the base prior to arranging the base in the mold.
   10. The method of any of the preceding claims, further comprising the step of affixing rubber dampeners to the steel edges after arranging the base in the mold, but before arranging the first outer composite layer on the base in the mold.
   11. The method of any of the preceding claims, wherein the mold is an aluminum cassette mold.
   12. The method of any of the preceding claims, wherein the inner composite layer comprises a sheet of carbon fiber composite.
   13. The method of claim 12, wherein the sheet of carbon fiber composite is biaxial or triaxial woven.
   14. The method of any of the preceding claims, wherein the first outer composite layer and the second outer composite layer each comprise a sheet of high modulus polypropylene composite.
   15. The method of claim 14, wherein the sheet of high modulus polypropylene composite is biaxial or triaxial woven.

The claims of the preceding paragraphs are intended to be illustrative rather than limiting.

### LIST OF REFERENCE NUMERALS

L longitudinal axis
100 snowboard
200, 300 multicore snowboard construction
210, 310, 410, 510, 610 wood core
220, 320, 520, 520, 620 inner composite layer
230, 330, 430, 530, 630 outer composite layer
240, 340, 440, 540, 640 base layer
250, 350, 450, 550, 650 top sheet layer
400, 500, 600 side edge configuration
460, 560, 660 steel edge
470, 670 sidewall
700 production method
701 preliminary preparation process
702 component assembly process
703 press forming process
704 finishing process

1. A snowboard having a multicore construction comprising:
a plurality of layers including a base layer forming a gliding surface of the snowboard, a first outer composite layer, a second outer composite layer, at least one inner composite layer, at least two wood cores, and a top sheet layer;
wherein the base layer is arranged adjacent to the first outer composite layer;
the first outer composite layer is arranged between the base layer and one of the at least two wood cores;
the at least one inner composite layer is arranged between two of the at least two wood cores;
the second outer composite layer is arranged between the top sheet layer and one of the at least two wood cores; and
the top sheet layer is arranged adjacent to the second outer composite layer.

2. The snowboard of claim 1, further comprising at least two inner composite layers and at least three wood cores, wherein each inner composite layer is arranged between two wood cores, and at least one wood core is arranged between two inner composite layers.

3. The snowboard of claim 1, wherein the snowboard has exactly two wood cores.

4. The snowboard of claim 3, wherein each of the two wood cores is approximately 2.5-3.5 mm thick.

5. The snowboard of claim 4, wherein each of the two wood cores is approximately 3 mm thick.

6. The snowboard of any of the preceding claims, wherein the wood cores together have a total thickness of approximately 5-7 mm.

7. The snowboard of claim 6, wherein the total thickness of the wood cores is approximately 6 mm.

8. The snowboard of any of the preceding claims, wherein the at least one inner composite layer comprises a sheet of carbon fiber composite.

9. The snowboard of claim 8, wherein the sheet of carbon fiber composite is biaxial or triaxial woven.

10. The snowboard of any of the preceding claims, wherein the first outer composite layer comprises a sheet of high modulus polypropylene composite.

11. The snowboard of claim 10, wherein the sheet of high modulus polypropylene composite is biaxial or triaxial woven.

12. The snowboard of any of the preceding claims, wherein the second outer composite layer comprises a sheet of high modulus polypropylene composite.

13. The snowboard of claim 12, wherein the sheet of high modulus polypropylene composite is biaxial or triaxial woven.

14. The snowboard of any of claims 1 through 9, wherein the first outer composite layer and the second outer composite layer each comprise a sheet of high modulus polypropylene composite.

15. The snowboard of claim 14, wherein the sheet of high modulus polypropylene composite is biaxial or triaxial woven.

16. A method for producing a snowboard having a multicore construction, comprising the steps of:
arranging a base with steel edges in a mold;
arranging a first outer composite layer on the base in the mold;
arranging a first wood core on the first outer composite layer in the mold;
arranging an inner composite layer on the first wood core in the mold;
arranging a second wood core on the inner composite layer in the mold;
arranging a second outer composite layer on the second wood core in the mold;
arranging a top sheet on the second outer composite layer in the mold; and
placing the mold in a press for a period of time under pressure and temperature to shape and join components of the snowboard.

17. The method of claim 16, further comprising the step of arranging a sidewall around sides of the first wood core, the inner composite layer, and the second wood core, prior to arranging the second outer composite layer on the second wood core in the mold.

18. The method of claim 17, further comprising the step of applying a bonding agent to the sides of the first wood core, the inner composite layer, and the second wood core, prior to arranging the sidewall around the side of the first wood core, the inner composite layer, and the second wood core.

19. The method of any of the preceding claims, further comprising the steps of:
applying a bonding agent to the base prior to arranging the first outer composite layer on the base in the mold;
applying a bonding agent to the first outer composite layer prior to arranging the first wood core on the first outer composite layer in the mold;
applying a bonding agent to the first wood core prior to arranging the inner composite layer on the first wood core in the mold;
applying a bonding agent to the inner composite layer prior to arranging the second wood core on the inner composite layer in the mold;
applying a bonding agent to the second wood core prior to arranging the second outer composite layer on the second wood core in the mold; and
applying a bonding agent to the second outer composite layer prior to arranging the top sheet on the second composite layer in the mold.

20. The method of claim 18 or 19, wherein epoxy is used for the bonding agent.

21. The method of any of the preceding claims, further comprising the initial steps of:
cutting two wood billets into a specified shape to form the first wood core and the second wood core;
planning each of the first and second wood cores to a specified thickness to accommodate the inner composite layer; and
cutting the inner composite layer to size for insertion between the first and second wood cores.

22. The method of claim 21, further comprising the step of vertically laminating pieces of wood together to form each of the two wood billets.

23. The method of claim 21 or 22, wherein a sidewall is added around the first and second wood cores prior to planning the first and second wood cores in order to correctly size the sidewall for later assembly.

24. The method of any of the preceding claims, further comprising the step of affixing the steel edges to the base prior to arranging the base in the mold.

25. The method of any of the preceding claims, further comprising the step of affixing rubber dampeners to the steel edges after arranging the base in the mold, but before arranging the first outer composite layer on the base in the mold.

26. The method of any of the preceding claims, wherein the mold is an aluminum cassette mold.

27. The method of any of the preceding claims, wherein the inner composite layer comprises a sheet of carbon fiber composite.

28. The method of claim 27, wherein the sheet of carbon fiber composite is biaxial or triaxial woven.

29. The method of any of the preceding claims, wherein the first outer composite layer and the second outer composite layer each comprise a sheet of high modulus polypropylene composite.

30. The method of claim 29, wherein the sheet of high modulus polypropylene composite is biaxial or triaxial woven.
